(19) United States
(12) Patent Application Publication
(10) Pub. No.: US 2005/0055255 A1
(43) Pub. Date: Mar. 10, 2005

(54) Method and system for analysing production of garments

(76) Inventors: Teo Puay Soo, Johor (MY); Man Kwok Chung, New Territories (HK); Kwan Wing Yin, Discovery Bay (HK)

Correspondence Address: FULWIDER PATTON LEE & UTECHT, LLP;HOWARD HUGHES CENTER, 6060 CENTER DRIVE, TENTH FLOOR, LOS ANGELES, CA, 90045, US

(21) Appl. No.: 10/231,368

(22) Filed: Aug. 29, 2002

(51) Int. Cl. G06F 17/60

(52) U.S. Cl. 705/8

(57) ABSTRACT

A method and system for estimating the production time of garments relies on measurement of operator motion times, and operator sewing times. The method and system also give production cost estimates by reference to respective costs associated with each operator motion and sewing action. The method and system further includes a video library of garments and parts of garments, by which estimates can be more easily produced.

### TECHNICAL FIELD

This invention relates to a method and system of determining the production time and cost of garments.

### BACKGROUND TO THE INVENTION

Methods and systems are known from which it is possible to estimate the cost and speed of production of mass produced garments. Typically a garment is considered as an assembly of parts joined together by a plurality of largely standard machine sewing steps. Thus the cost and standard production time of a garment can be ascertained by identifying these individual steps and adding the standard sewing times. The GSD system identifies for example 36 standard sewing elements, to which must be added a time and cost allowance for non-sewing activities.

Accurate estimation of cost and speed of production is essential if the manufacturer is to produce garments on time, and at a cost which enables a profit to be made. Such estimates also permit staff and machine resources to be planned. However, present systems do not permit sufficiently accurate estimates to be generated.

### SUMMARY OF THE INVENTION

According to a first aspect of the present invention, a method of estimating the production time of a garment comprises the steps of determining for each production step a motion sequence code comprising operator motion time and operator sewing time, and summing said motion sequence codes to give a production time estimate.

Non-sewing motions may include marking, cutting, clamping, pressing, positioning, finishing and packaging. By analysing non-sewing and sewing motions separately, account can be taken of different timings for slightly different components, of differences in operator and machine, of component transport between operator stations, and other non-standard aspects. Furthermore each non-sewing motion may be considered independently with available alternatives, so as to give the best achievable production time for a predetermined production facility. It will be understood that some motion sequence codes have no sewing time, because the operation is not a sewing step. In this case the operator sewing time is zero.

Each motion sequence code typically comprises a plurality of different activities. For example sewing a patch pocket may include the steps of positioning a paper template on the substrate, marking the position of the pocket on the substrate, positioning the pocket on the substrate marks, sewing the pocket to the substrate, and finishing (for example buttoning).

Separate analysis of motion time and sewing time also permits more accurate costing according to the skill level and pay rate of the operator. Thus each motion and sewing step may be costed according to standard costs for the respective task. Low skill tasks will typically have a standard cost lower than a high skill task. The separate analysis permits standard costs to be varied according to pay rates at a respective production facility, and accordingly a more accurate time and cost estimate may be obtained.

According to a preferred embodiment a system for use in the method utilizes a look-up table in any suitable form to store motion time and sewing time for each production step of a garment. Preferably the system is embodied in the form of a computer comprising a processor, a ROM containing motion times and sewing times, and menu driven software whereby a user can select a garment type, and said processor will calculate production time by reference to the components of the garment and information from said ROM.

In the preferred embodiment the menu driven software is adapted to display graphic images of garments, and to permit a user to select one of a plurality of garment images. Furthermore the software is preferably adapted to allow components of a garment to be substituted in the image, by reference to a range of alternatives, and to recalculate production time according to operator choice.

In this way a user may select a garment, for example a dress, and then select options such as long sleeve, short sleeve, no sleeve in order to arrive at an accurate production time. Where time is of the essence of production, such alternatives permit an estimate to be tailored to the production time available, by selecting garment options which meet the production schedule.

In addition to garment production time, the invention also permits standard non-sewing tasks to be estimated according to the production requirements of the purchaser. Such tasks typically comprise motion sequence times for enrobing and/or boxing garments, and may also include transportation.

A computer system embodying the present invention may also include a register to store specific garment specifications comprising a sum total of operator motion times and operator sewing times. Such a register is useful in case of a repeat order, and avoids the possibility of an error which may be introduced during re-specification.

In a preferred embodiment the system for use in the method of the present invention may incorporate a second look-up table which relates each motion time and sewing time to a standard cost. This second table may be a ROM of a computer system in which costings may be in several ranges according to local production facilities, wage rates etc. Accordingly a user may select one of several production facilities having different costs of production, and obtain a standard production costing dependent on the production time estimate, and the individual components thereof.

Preferably the method of the invention is embodied in a P.C. based system, and is also adapted to be accessed via the Internet. In this embodiment graphic images of garments are displayed on a p.c. monitor, and are manipulated using menu driven software.

In a preferred embodiment the system of the invention utilizes a database for components and a database for styles. The component database may list and preferably illustrate every different component which may be utilized in garment production. The style database lists and preferably illustrates every different style. It will be appreciated that new components and new styles may be added from time to time in the form of ROM upgrades, or as temporary data stored in a RAM as a result of active on-line styling in real time. Such temporary data is available for re-use until substituted by permanent data in the form of a ROM.

Each style may be accorded a handling index according to the difficulty of manufacture. Such index may indicate that only certain production facilities, machines or operators are qualified for the task, or for parts of the task. The handling index may also indicate a cost uplift, for example as a percentage to be applied to the production cost estimate.

Each component may include optional features to be selected by the user, and which result in a corresponding adjustment of production time and cost. Such a feature may be for example double sewing of a seam.

In a preferred embodiment each step in the production process is illustrated as a sequence showing a predetermined assembly order, and the pre-assembly operations required for each component. This permits a critical path to be determined for minimum production time.

The system may include a third look-up table which defines the kind of machine and number of operators required for each motion and sewing activity. Such an arrangement is useful in matching the characteristics of a particular production facility to a garment order.

In particular the system utilizes each motion sequence code by reference to a machine and/or operator, to determine the output per hour or per day, and the number of machines and/or operators required to fulfil the order within a given time. Alternatively the system permits estimation of the production time for an order using a predetermined number of operators and/or machines.

It will be understood that various access levels may be permitted for a p.c. based system according to the invention. In one embodiment a general access level, for example controlled by password, permits access to ROM data for estimation of e.g. production times. A higher manager level access, also controlled by password, may permit changes to certain parameters, storage of new information, or access to sensitive data such as wage rates, production targets etc.

### BRIEF DESCRIPTION OF DRAWINGS

Other features of the invention will be apparent from the following description of a preferred embodiment shown by way of example only in the accompanying drawing, which illustrates an operational flow chart for costing garments according to the present invention, and for estimating production time.

### DESCRIPTION OF PREFERRED EMBODIMENTS

Referring to the drawing there is shown an operational flow chart for a Garment Time Measurement (GTM) system according to the present invention. For purposes of description, the operation of the GTM system can be conveniently divided into a first part 10 for providing a preliminary costing/time estimate, a second part 12 for providing a final costing/time, and a third part 14 for providing various analysis and reporting operations. In the preferred embodiment the GTM system is accessed via a personal computer.

When a new estimate is required the GTM system refers a user to a database comprising a sketch library. The sketch library has a style database containing information on various styles of garments, and a parts database containing information on various parts or components of garments. The user selects the required garment from the sketch library, for example by consulting a menu, and may choose to modify that garment by reference to alternative parts. Thus for example a different collar may be selected for a particular style of dress. Alternatively a part may be selected from the sketch library by reference to a garment style (which necessarily consists of an assembly of parts).

When the design of the garment is finalised, the GTM system performs an operation analysis based on information from an operation database. The operation database includes information on sewing and non-sewing motions, and presents in a logical sequence each step in the garment manufacturing process. Each production step comprises a motion sequence code of one or more operator motion times and/or one or more operator sewing times. The motion sequence codes include a time to the nearest second for completion of the production step.

A user of the GTM system will typically consider the successive motion sequence codes to ensure that the manufacturing sequence is correct, or to choose the order of some codes. For example the user may decide, optionally, that a collar should be sewn before a cuff. It is anticipated however that most motion sequence codes will be correctly ordered and the user will merely need to select the required codes for finishing or packing, from a list of options.

In the preferred embodiment, the detailed operation of the preferred GTM system is based on 118 motion sequence codes contained in the operation database. Previous systems have relied solely on general sewing data for analysing the sewing process only. The motion sequence codes are used to characterise each step involved in garment production such as sewing, marking, drawing, pressing, cutting, finishing and packaging processes. The time values, expressed as Time Measurement Units (TMUs), for all of the manual motions/processes are added together, resulting in a standard time for each manual operation for a particular stage or step in garment production. The TMUs are added together to calculate the production time requirements for each garment, and ultimately an entire order.

At this point the user may be referred to a video library of the various stages in the operation database, which allows the user to study the motion sequence in question, and to choose an optimised operation sequence. The video clips typically illustrate garment style and part structure as well as operation method and can also be used as part of a training aid or as a quality assurance process. The video clips can further provide evidence to the management and workforce that the time values are reasonable for a given task or operation.

The first part 10 of the GTM system also provides a preliminary cost estimate for the production of garments by reference to standard labour costs. The user may use this information to decide a production location, in order to match the preliminary estimate most closely to the expectation of the customer.

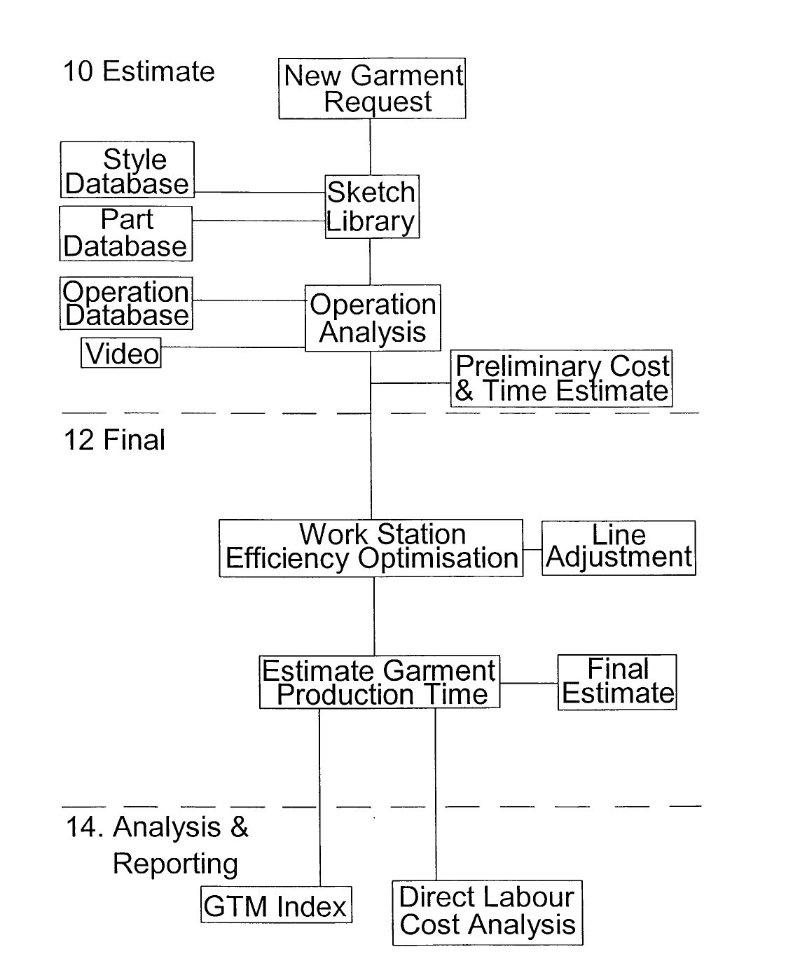

The second part 12 of the operational flow chart of FIG. 1 indicates how the GTM system can be used in a workforce analysis based on information contained in a daily production database and an employee database. The workforce analysis is typically performed to determine the capacity which a machine, production line or plant can handle when taking the employee skill and attendance into account. This step provides a capacity management tool to determine the number of garments that can be manufactured. It will be appreciated that such a workforce analysis is a varying parameter and this is provided for by allowing the daily production and employee databases to be updated independently of initial estimation of cost and time.

Each production location may for example have relevant data stored in a memory, including for example employment and overhead costs, number and type of machines, experience and ability of workforce, and so on. The GTM system may be used to match the garment production requirements to the optimum production location, or provide for example estimates of the top five production locations. Managers at each location may actively bid for work by adjusting labour rates etc., and accordingly increase the chance of being selected for a production contract.

Upon completion of the workforce analysis, the GTM system may be used to perform a work station efficiency optimisation stage. This stage is capable of balancing a production line to determine the optimum type and number of machines to workforce ratio. For example, a particular garment may require three skilled cutters and two skilled sewers to operate most efficiently so that excess work in progress is avoided. The GTM system can provide the information to indicate that a line adjustment is required, which can be performed and implemented on a production line, in real time if required. The GTM system may also perform an operation to estimate the overall garment production time to provide a final estimate, taking into account iterative adjustments to the production line.

The third part 14 of the operational flow chart of FIG. 1 provides an analysis and reporting function whereby the user can access and process the information generated by the GTM system to provide information on GTM index, and direct labour costs. The third part 14 is integrated with production feedback control and payroll and can be used for high level corporate analysis.

The GTM system therefore provides computer software to manage the Standard Time Measurement (STM) data for a complete garment manufacturing process including production line workstation efficiency balancing. The software typically iterates 100 times to obtain a simulated optimised station efficiency balancing, in seconds. This balancing also incorporates features to optimise machines, tools, fixtures and factory layout improvements. Currently this balancing process is much slower whereby additional operators are physically placed at locations of increased work in progress in an attempt to smooth the flow of work. It will be appreciated that a manual process often creates problems down line necessitating further line intervention.

The advantageous style/part operation structure sets a tree relationship for a complete garment so that the main parts and assembly of the garment can be seen by a user of the GTM system. The tree structure allows the software to compute total Standard Applied Minutes (SAMs) for any style, part or operation retrieved from the database. The station efficiency balancing operation optimises each production line work station based on the SAMs. Following work station efficiency optimisation the GTM system may utilize known software to automatically programme machinery to undertake the process of manufacturing the selected garment.

The following example for producing a garment provides further explanation on the operational steps of the GTM system. A centre equipped with the GTM system initially receives a requisition to produce a garment or series of garments. The requisition is generated by a user, and requires basic operational data such as the request number, time, date, customer, style, garment type and order quantity. Typically this date is input in a form dictated by the GTM system, and preferably by interactive use of GTM system software.

The GTM system is configured to allow the user to perform a style query operation subsequent to the requisition. This is performed in a quick and convenient way by allowing the user to enter the style database and to view images of garment styles on screen. The style query allows the user to determine whether similar garment styles have been previously manufactured.

In the case that the same garment cannot be identified, the system allows a user to identify a similar garment, and to copy the relevant GTM code, and to save it as a new style for possible alteration. The code is typically in the form of a string of alphanumeric characters that identify component parts of the style, the manufacturing operations that are performed on the parts and the sequence of performing the operations. The system permits the user to enter a parts database to view the individual steps of the computer code, and to delete the steps of the code that are not required and/or to add new steps for an alternative style. The parts database uniquely identifies each part of the garment with a part code, a title and a SAM.

The GTM system also permits a new style to be created if the user cannot find a similar garment style to the requisition. The new style is created by the user by keying in new style information to all of the respective fields in the style database. This new style information may be obtained from an external or internal source to the GTM system such as a design document or a design look up table. The user selects the parts or similar parts for the new style from the parts database. If necessary similar parts may be altered by changing the relevant codes. If a similar part cannot be found the user can create a new part by keying in new part information to the respective fields in the parts database. This new part information may be obtained from an external or internal source to the GTM system such as a design document or a design look up table. The user can add the modified part or newly created part to the new style. Each part can be added in any sequence as required.

It will be understood that the process of selecting a garment results in the GTM system automatically assigning and placing in order the required manufacturing operations.

An analysis of the operations that each part undergoes during manufacture may then be performed. Each operation may be checked and unnecessary operations deleted, as required. Alternative operations (if required) can be substituted by selecting or amending a similar operation obtained from the operations database. The user may also create a new operation code if a sufficiently similar operation cannot be found and modified. A new operation is created by keying in new operation information in the respective fields in the operation database. The new operation information may be obtained from an external or internal source to the GTM system such as the operation database or operation manual. Each operation can be added to the part in the required sequence so that the operations are executed to produce the part and garment in the most efficient way. Machine TMUs and manual TMUs can then be summed to provide the total TMU.

In this way the automatic sequence produced by the GTM system can be adjusted or tuned in the light of practical experience.

Once the style, part and operation analysis has been completed the user is able to perform an analysis to ensure balancing of the manufacturing line. This optimises the efficiency of workstations and operatives to optimise the efficiency of production. The desired style is selected from the style database and the parts and operations for that style are auto-retrieved to perform the analysis. The user may key in constraints and criteria which affect line balancing in a particular location, for example parameters such as work-station efficiency and available number of workers, and the GTM system performs an auto-simulation to suggest the most efficient configuration of the line. The outputs of the simulation being, for example the total workers required, the output per hour, the output per day, the line utility, the minimum time per piece and the total GTM. The user may thus pick the preferred configuration based on the auto-simulation. The GTM system permits a user to fine tune the configuration if necessary, for example by observing the effect of adjusting the number of workers. A final simulation is performed following fine tuning to obtain the finalised configuration. The GTM system also has several levels of authority. For example a Manager level user is allowed to enter a change control to release the Engineering Change Order (ECO) to effect the changes in part, style and operation. This provides a centralised way of controlling the operation of the overall GTM system. The manager level user enters the ECO creation function to provide the authorisation to effect the new style. The GTM system then executes the new ECO to provide a release status for a new style. The GTM system is initialised so that users lower than the manager level user can only use release data, therefore providing a simple method for managers to control the change of styles and to prevent unauthorised changes to the GTM system.

The system is able to provide production reports from the GTM system which can illustrate the style sketch, the style code, the parts breakdown, the customer, the garment type, the total SAM, the sewing SAM, the part code, the operation code, the part title, the machine and the machine description. The production report function can also link into the video database of operations to provide further means for training and analysis. Further information on the machine and accessory statistics can also be generated.

The production report function may also provide information on the workplace design and layout. The layout reports contain detailed information on the layout description in sequential steps to provide further training and analysis options.

The production report function further provides information on station efficiency balancing and man hour resources. Typically such information will be illustrated in the form of a table illustrating station efficiency as a percentage with respect to a particular part, station, machine or worker. This function provides a convenient means for monitoring real time or historical line operation.

The production report function also provides dynamic style reports to monitor engineering standard time improvement. Such information provides an historical monthly GTM index whilst also illustrating the average and daily GTM index. Historical direct labour cost estimation, sub SAM statistic report and status reports can also be generated.

By providing detailed information on sewing and non-sewing activities, it will be appreciated that very significant advantages are provided, particularly in controlling precisely the manufacturing operation, whilst giving considerable flexibility to adjust that operation interactively.

1. A method of estimating the production time of a garment, comprising the steps of determining for each production step a motion sequence code comprising operator motion time and operator sewing time, and summing said motion sequence codes to give a production time estimate.

2. A method according to claim 1 wherein operator motion time comprises one or more of marking, cutting, clamping, pressing, positioning, finishing and packaging.

3. A method according to claim 1 and further including the steps of providing a first look-up table of operator motion times, providing a second look-up table of operator sewing times, and generating said motion sequence code by reference to said first and second look-up tables.

4. A method according to claim 3 wherein said first and second look-up tables comprise a read only memory of a computer.

5. A method according to claim 1 and further comprising the steps of determining for each motion sequence code, a motion sequence cost, and summing said motion sequence costs to give a production cost estimate.

6. A method according to claim 6 wherein each motion sequence cost comprises a motion cost for one or more operator motions, and/or a sewing cost for one or more sewing operations.

7. A computer system for estimating the production time of a garment and comprising a processor, a first read only memory containing for each production step of the garment one or more operator motion times and/or one or more operator sewing times, and menu driven software for calculating production time by reference to the sum of said operator motion times and operator sewing times.

8. The computer system of claim 7 and further comprising an electronic garment library having garment manufacturing data of a plurality of garments therein, said garment manufacturing data comprising for each garment a plurality of garment specific production steps, each of said steps comprising an operator motion time and/or an operator sewing time.

9. The computer system of claim 8 wherein said electronic garment library further comprises a plurality of garment parts, each of said parts having part manufacturing data therefor, and said part manufacturing data comprising a plurality of part specific production steps each comprising an operator motion time and/or an operator sewing time.

10. The computer system of claim 8 and further including a visual display adapted to show graphic images of said garments and said garment parts of said library, and to permit selection of alternative garment parts for a garment, for calculation of a respective production time.

11. The computer system of claim 10 and adapted to display a revised graphic image of a garment having an alternative part.

12. The computer system of claim 11 and adapted to retain said revised graphic image and garment manufacturing data thereof as an additional garment of said garment library.

13. A computer system according to claim 7 and further comprising a second read only memory containing for each production step of the garment one or more manufacturing costs associated therewith.

14. A computer system according to claim 13 wherein said manufacturing costs comprise one or more motion sequence costs associated with operator motion time, and/or one or more operator sewing costs associated with operator sewing time.

15. A computer system according to claim 7 and further including a video library comprising a plurality of video clips associated with a respective plurality of production steps of a garment, a video clip being playable on demand by reference to a selected production step.

16. A computer system according to claim 7 and further including a third read only memory containing for each production step a register of machines capable of fulfilling the said production step, and a register of the number of operators required for fulfilling each production step.

17. A computer system according to claim 12 and further including a lower and a higher access level, the higher access level being password protected and permitting retention of a revised graphic image as an additional garment of said library.

18. An Internet based system for estimating the production time of garments and comprising a central processing unit, and one or more remote personal computers adapted to access the central processing unit via the Internet, the central processing unit comprising a library of graphic images of garments, and a first read only memory containing for each production step of a respective garment one or more operator motion times and one or more operator sewing times, said library being displayable on said one or more remote personal computers together with a garment production time estimate comprising the sum of respective operator motion times and operator sewing times.

19. An Internet based system according to claim 19 wherein said library further includes graphic images of parts of a plurality of garments, and said read only memory contains for each of said parts, respective operator motion times and/or operator sewing times.

20. An Internet based system according to claim 19 and wherein said central processing unit further includes a second read only memory containing for each production step of a respective garment, a manufacturing cost associated therewith, a production cost estimate comprising the sum of said manufacturing costs being displayable on said one or more remote personal computer.
